(19) United States
(12) Patent Application Publication
(10) Pub. No.: US 2014/0325345 A1
(43) Pub. Date: Oct. 30, 2014

(54) Consistent Scaling of Web-Based Content Across Devices Having Different Screen Metrics

(71) Applicant: Amazon Technologies, Inc., (US)

(72) Inventors: Tyler James Vano, Irvine, CA (US); Damon Maghsoudi, Rancho Santa Margarita, CA (US); Rahul Ravikumar, Irvine, CA (US)

(21) Appl. No.: 13/871,140

(22) Filed: Apr. 26, 2013

(51) Int. Cl. G06F 17/21

(52) U.S. Cl. CPC G06F 17/211
USPC 715/236; 715/243

(57) ABSTRACT

Concepts and technologies are described herein for consistent scaling of web content across devices having different screen metrics. According to some of the concepts and technologies disclosed herein, a computing device may receive web content and select a scaling factor for scaling the web content for presentation on a screen component associated with the computing device. The computing device may select a scaling factor for scaling the web content and utilize the scaling factor and a screen metric of the screen component to calculate a value, which the computing device may then apply to a font size property of a root document object model (“DOM”) node of the web content. The computing device may then scale the web content for presentation on the screen component based upon the value of the font size property and rem units defined in the web content.

### BACKGROUND

Mobile devices, such as smartphones, e-book readers, and tablets, have become increasingly popular over the last several years. The most common mobile operating systems are the ANDROID operating system, available from Google Inc., Mountain View, Calif., and the IOS operating system, available from Apple Inc., Cupertino, Calif. The ANDROID operating system is free and open source. The ANDROID operating system has gained significant market share in recent years, and this trend will likely continue as many hardware and software developers gravitate towards the flexibility offered by the open nature of the ANDROID operating system. The IOS operating system, however, is a proprietary system installed on smartphones, tablets, and other devices manufactured and sold by Apple Inc. The closed nature of the IOS operating system allows Apple Inc. to strictly manage all aspects of the IOS ecosystem, including the hardware specifications, such as screen size, screen density (e.g., pixels per inch), and screen aspect ratio, of devices on which the operating system executes. The ANDROID and IOS operating systems both have strengths and witnesses as a result of their distribution models.

The high-level of integration of Apple Inc. hardware and software provides developers with a stable platform upon which to develop software applications. A downside to the high-level of integration offered by Apple Inc. is that hardware innovation, such as moving to larger screen sizes, different form factors, and the like, is solely at the discretion of Apple Inc., and often leaves consumers with little to no choice with regard to display size and other hardware specifications when purchasing a mobile device from Apple Inc. The open nature of the ANDROID operating system, however, constantly welcomes new hardware and software developers, and as a result, the ANDROID operating system is available on a huge variety of devices with different hardware specifications, such as screen size, screen density, and screen aspect ratio. In addition to the variety of devices that execute the ANDROID operating system, many of these devices differ wildly from the ANDROID specifications, and in some cases, outright misrepresent their actual hardware configuration. This makes delivering a consistent user experience to all ANDROID customers a notoriously difficult problem for software developers.

It is with respect to these and other considerations that the disclosure made herein is presented.

### BRIEF DESCRIPTION OF THE DRAWINGS

FIG. 1 is a system diagram showing an illustrative operating environment for the various embodiments disclosed herein;

FIG. 2 is a flow diagram showing aspects of a method for scaling web content, according to one illustrative embodiment;

FIG. 3 is a flow diagram showing aspects of a method for scaling web content, according to another illustrative embodiment;

FIG. 4 is a computer architecture diagram showing one illustrative computer hardware architecture for use in computing devices configured to implement the concepts and technologies disclosed herein in one embodiment.

### DETAILED DESCRIPTION

The following detailed description is directed to consistent scaling of web-based content across devices having different screen metrics. As explained above, the ANDROID ecosystem contains devices with a huge variety of screen sizes, densities, and aspect ratios, many of which differ wildly from ANDROID specifications or outright misrepresent their actual hardware configuration. This makes delivering a consistent user experience to all ANDROID customers a notoriously difficult problem for software developers.

The concepts and technologies disclosed herein for consistent scaling of web-based content across devices having different screen metrics can be utilized by developers to deliver a consistent user experience with their software applications. Although certain concepts and technologies described herein are described with reference to the ANDROID operating system, it should be understood that the concepts and technologies described herein are not limited to the ANDROID operating system in any way, and can be utilized to provide consistent scaling of web-based content across devices having different screen metrics regardless of the particular operating system executing on the device.

According to some of the concepts and technologies disclosed herein, a computing device may receive web content and select a scaling factor for scaling the web content for presentation on a screen component associated with the computing device. The computing device may select a scaling factor for scaling the web content and utilize the scaling factor and a screen metric of the screen component to calculate a value, which the computing device may then apply to a font size property of a root document object model (“DOM”) node of the web content. The scaling factor may be selected based upon a generalized screen size or a calculated diagonal size of the screen component, as will be described in various embodiments herein. The computing device may then scale the web content for presentation on the screen component based upon the value of the font size property and rem units defined in the web content

The concepts and technologies are often described in context of hybrid device applications written utilizing web technologies, such as, but not limited to, HyperText Markup Language (“HTML”), Cascading Style Sheets (“CSS”), and JAVASCRIPT. As used herein, a “hybrid application” is a software application configured to execute on a device within a native container and to leverage a rendering engine, such as WEBKIT, to process markup language code, such as HTML, style sheet code, such as CSS, and scripting code, such as JAVASCRIPT, to provide some functionality that utilizes web content. It should be understood that these embodiments of the concepts and technologies described herein are illustrative, and should not be construed as being limiting in any way.

It should be appreciated that the subject matter presented herein may be implemented as a computer process, a computer-controlled apparatus, a computing system, or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures, and other types of structures that perform particular tasks or implement particular abstract data types.

Those skilled in the art will also appreciate that aspects of the subject matter described herein may be practiced on or in conjunction with other computer system configurations beyond those described herein, including multiprocessor systems, microprocessor-based or programmable consumer electronics, minicomputers, mainframe computers, handheld computers, personal digital assistants, e-book readers, cellular telephone devices, special-purposed hardware devices, network appliances, and the like. The embodiments described herein may be practiced in distributed execution environments, where tasks are performed by remote processing devices that are linked through a communications network. In a distributed execution environment, program modules may be located in both local and remote memory storage devices.

In the following detailed description, references are made to the accompanying drawings that form a part hereof, and that show, by way of illustration, specific embodiments or examples. The drawings herein are not drawn to scale. Like numerals represent like elements throughout the several figures.

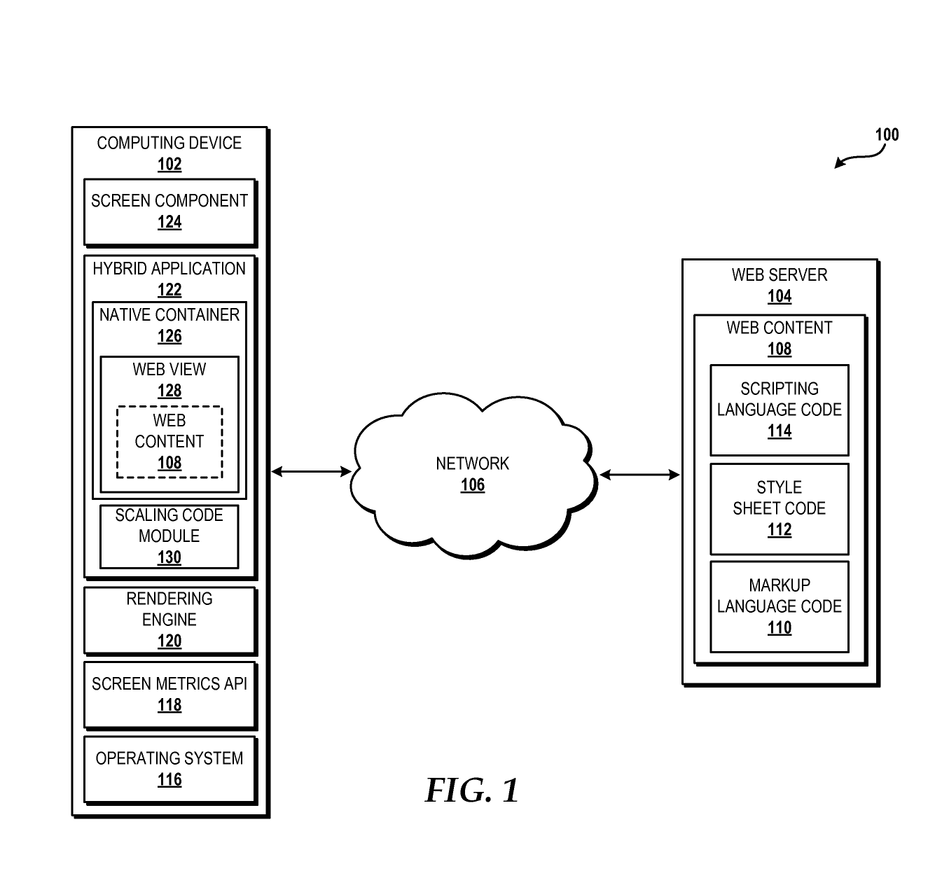

FIG. 1 and the following description are intended to provide a brief, general description of a suitable computing environment in which the embodiments described herein may be implemented. In particular, FIG. 1 is a system and network diagram that shows an illustrative operating environment 100 including several hardware and software components for implementing consistent scaling of web-based content across devices having different screen metrics. The operating environment 100 is merely illustrative and the embodiments disclosed herein might be utilized in many different types of environments.

The operating environment 100 shown in FIG. 1 includes a computing device 102. The computing device 102 may be a tablet computer, smartphone, personal digital assistant (“PDA”), e-book reader, game console, set-top box, desktop or laptop personal computer, server computer, or any other computing device. The computing device 104 can access one or more web servers 104 over a suitable data communications network 106 (“network 106”), which may be a wide area network (“WAN”), local area network (“LAN”), metropolitan area network (“MAN”), other area network, combinations thereof, and the like, to access web-based content (hereinafter “web content”) 108. In the illustrated example, the web content 108 is provided, at least in part, by markup language code 110, style sheet code 112, and scripting language code 114, as shown in the illustrated example. The web content 108 may include text, images, sounds, videos, animations, video games, music, movies, e-mail, other messages, web pages, e-commerce data, or any other data that is made available via the World Wide Web alone or in any combination.

The markup language code 110 marks the web content 108 up into different structural elements, such as, for example, paragraphs, blocks, lists, images, tables, forms, comments, and the like. The markup language code 110 may include code written in any markup language, such as, but not limited to, HTML, Extensible Markup Language (“XML”), Extensible HTML (“XHTML”), combinations thereof, and the like.

The style sheet code 112 defines how each element defined by the markup language code 110 is to be represented. In other words, the style sheet code 112 defines the style of the different structural elements represented in the markup language code 110. The style sheet code 112 may include code written in a style sheet language such as, but not limited to, CSS.

The scripting language code 114 defines how elements within the web content 108 respond to events. The scripting language code 114 may include code written in a scripting language such as, but not limited to, JAVASCRIPT.

The markup language code 110, the style sheet code 112, and the scripting language code 114 may be stored by or for the web server 104 in one or more data storage components, such as hard disks, solid state drives, tape drives, combinations thereof, or the like (not shown). The data storage component(s) may be local or remote to the web server 104. The markup language code 110, the style sheet code 112, and the scripting language code 114 may be stored in the data storage component(s) as separate files, or may be combined in one or more files. Although not shown in the operating environment 100, the web server 104 may include hardware and software components to provide the web content 108 to the computing device 102 via the network 106. The web server 104 may provide the web content 108 to other computing devices in addition to the computing device 102.

The computing device 102 can execute an operating system 116, such as the ANDROID operating system, and one or more software components, such as, in the illustrated example, a screen metrics API 118, a rendering engine 120, and a hybrid application 122. The screen metrics API 118 may exposed by the operating system 116 to allow access to screen metrics of a screen component 124 of the computing device 102. The screen metrics may include, for example, screen width, screen height, screen diagonal, screen density, and screen resolution of the screen component 124. The values for screen width, screen height, and screen diagonal provided by the screen metrics API 118 may be in inches, centimeters, millimeters, or some other unit of length. The value for screen density may be in pixels or “dots” per inch or some other unit of length. The value for screen resolution may be provided as a number of pixels in each dimension of the screen component 124. The screen component 124, for example, might have a width of 1920 pixels and a height of 1200 pixels, and so a screen resolution of 1920 pixels by 1200 pixels. It should be understood that this example is illustrative, and should not be construed as being limiting in any way.

The rendering engine 120 is configured to render the web content 108 received from the web server 104 by, at least in part, parsing the markup language code 110 to construct a document object model (“DOM”) tree, constructing a render tree, laying out the render tree, and painting the render tree. More particularly, the rendering engine 120 may use tags (e.g., HTML tags) in the markup language code 110 to create DOM nodes, each of which represents different elements of the markup language 110, and to construct a DOM tree from the DOM nodes. The rendering engine 120 may also parse the style sheet code 112 and use the parsed style sheet code along with style elements parsed from the markup language code 110 to construct a render tree. The render tree may contain rectangles or other shapes with visual attributes, such as color and dimensions, arranged in an order in which the shapes are to be displayed. The rendering engine 120 may then layout the render tree so that each node is given the exact coordinates where it is to be presented on the screen. The rendering engine 120 may then paint the render tree in accordance with the specifications provided in the style sheet code 112. It should be understood that the rendering engine 120 may provide more or less functionality than described above so as to render the web content 108 on the computing device 102 in accordance with the concepts and technologies disclosed herein.

In some embodiments, the rendering engine 120 is provided as part of WEBKIT, although other rendering engines are contemplated. The rendering engine 120 may be accessible via one or more APIs (not shown). In general, the rendering engine 120 may provide a set of core classes, which may be utilized to render the web content 108 within applications, such as the hybrid application 122, in the illustrated embodiment.

The illustrated hybrid application 122 includes a native container 126 in which a web view 128 is provided. The web view 128 allows the hybrid application 122 to access the rendering engine 120 to render the web content 108 within the hybrid application 122. For example, a developer may program the hybrid application 122 such that the web view 128 points to a uniform resource locator (“URL”) of a website provided, at least in part, by the web server 104. In this example, the hybrid application 122, when executed by the computing device 102, can cause the computing device 122 to access the web server 104 over the network 106 to retrieve content, such as the web content 108, that is associated with the website, and to display the web content 108 within the web view 128. The web view 128 may be provided as a window within the hybrid application 122 or full screen. The web view 128 may be provided alone, as in the illustrated embodiment, or together with one or more other web views, which may be configured to display at least a portion of the web content 108 and/or different web content.

The illustrated hybrid application 122 also includes a scaling code module 130, although the scaling code module 130 alternatively may be provided outside of the hybrid application 122. The scaling code module 130 may include code programmed in one or more languages compatible with the rendering engine 120. For example, the scaling code module 130 may include JAVASCRIPT code, JAVA code, objective C, or other code in any other language compatible with the rendering engine 120.

The scaling code module 130 is configured to calculate a screen scaling metric. The screen scaling metric can be used as a scaling factor for the hybrid application 122 so that a user interface of the hybrid application 122 appears consistently across multiple devices, including the computing device 102 and other devices having different screen metrics, such as screen size, screen density (e.g., pixels per inch), and screen aspect ratio. In this manner, the scaling code module 130 can be used to reliably measure the actual useable screen size of the computing device and use the screen size as a baseline from which auto-scale a user interface.

In some embodiments, the scaling code module 130 may be configured to execute on startup of the hybrid application 122 and begin a polling operation during which the scaling code module 130 waits for the rendering engine 120 to report consistent screen metrics, such as screen width and screen height. The screen metrics may be considered “consistent” when the screen metrics reported by the rendering engine 120 fluctuate within a specified range, do not fluctuate, or fluctuate within a specified range for a specified period of time. In these embodiments, the scaling code module 130 also may be configured to take the average of the screen metrics from the polling operation to determine a generalized screen size.

Generalized screen sizes may be pre-defined by the operating system 116, may be pre-defined in the scaling code module 130, or may be pre-defined elsewhere within or external to the computing device 102. Each generalized screen size may include a range of actual screen sizes. For example, two devices that report one generalized screen size might have actual screen sizes that are slightly different when measured by hand. By way of example and not limitation, the generalized screen sizes may include small, medium, large, and extra-large screen sizes, which each define a range of screen sizes in inches or some other unit of length.

The scaling code module 130, in these embodiments, also may include pre-defined percentages mapped to the generalized screen sizes. The pre-defined percentages may be experimentally determined and programmed into the scaling code module 130. Alternatively, the pre-defined percentages may be defined in accordance with a design specification. The scaling code module 130 may be configured to select the pre-defined percentage mapped to the generalized screen size of the computing device 102, and to apply the selected pre-defined percentage of the screen metrics as the font size on the root DOM node of the web content 108, as will now be described below in detail.

As described above, the web content 108 includes the markup language code 110 and the style sheet code 112. The rendering engine 120 can construct a DOM tree from the markup language code 110 and the style sheet code 112. The root node of the DOM tree (e.g., the HTML element for HTML code) includes a font size property. The scaling code module 130 can manipulate the root node to set the font size property equal to the selected pre-defined percentage of the screen metrics.

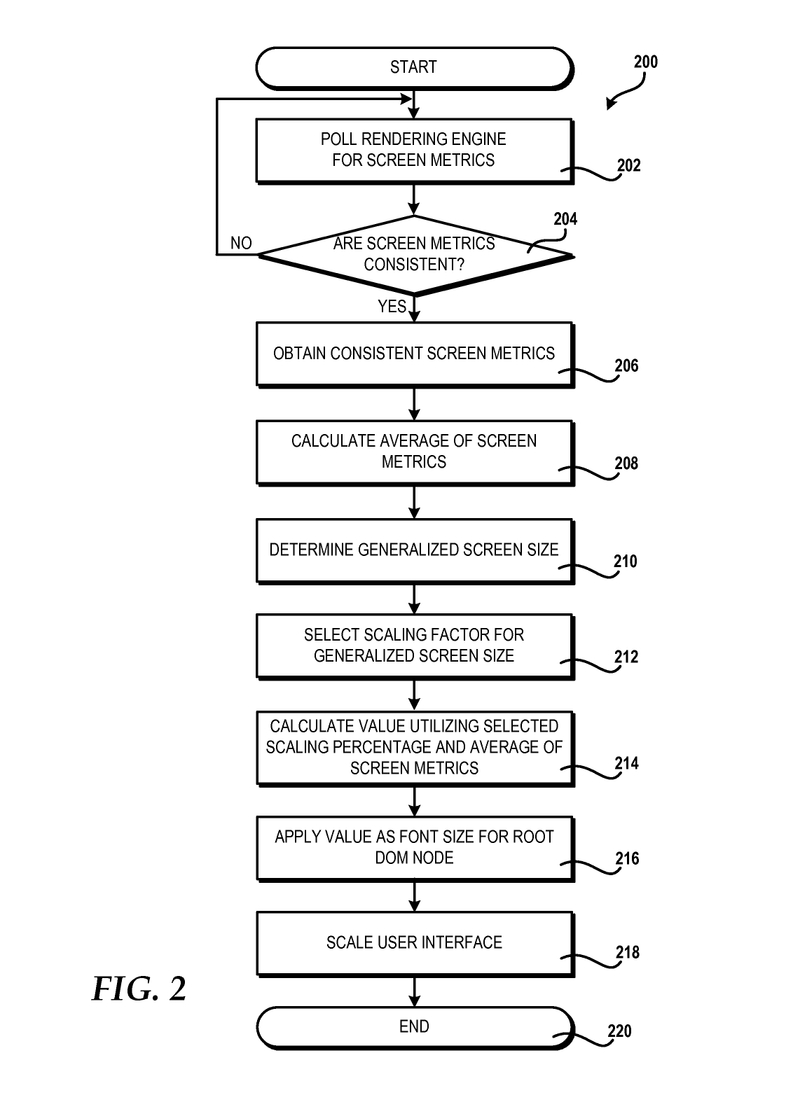

The style sheet code 112 can define font sizes for the remaining nodes in “em” units, root em (“rem”) units, or other relative units. A rem unit is relative to the root node of the DOM tree. Using rem units, the root node can be defined as a single font size (i.e., the selected pre-defined percentage of the screen metrics) and define all rem units to be a percentage of that font size. The selected pre-defined percentage of the screen metrics set as the font size of the root node will cause all other font sizes within the DOM tree to be sized relative to the font size of the root node so that the user interface of the hybrid application 122 can be consistently scaled across different screen sizes. Additional details regarding these embodiments are described below in detail with reference to FIG. 2.

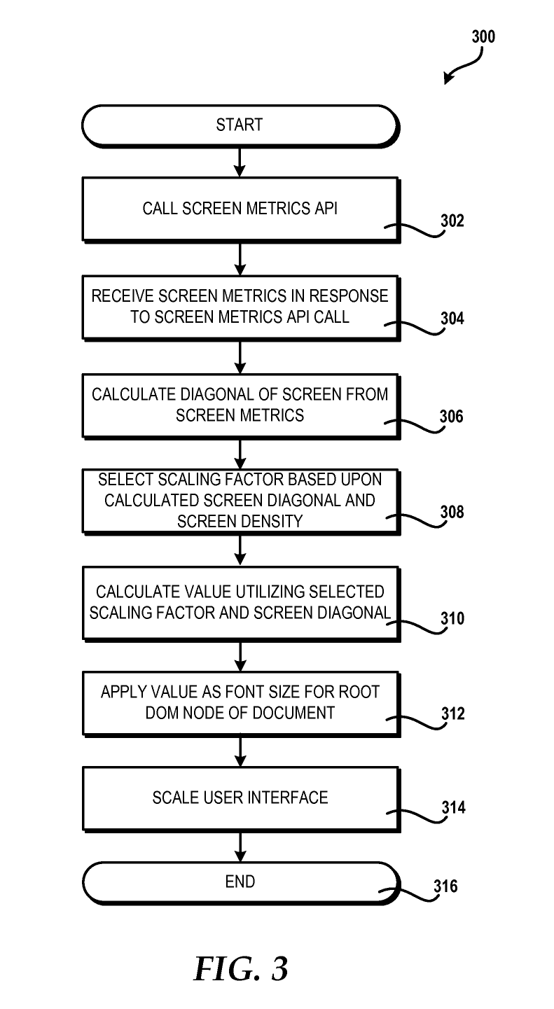

In some other embodiments, the scaling code module 130 is configured to call the screen metrics API 118 exposed by the operating system 116 to obtain screen measurements (e.g., width and height of screen) for the screen component 124, to calculate a diagonal value for the screen component 124 based upon the screen measurements, and to select the screen scaling metric from a plurality of pre-defined screen scaling metrics based upon the diagonal value of the screen component 124. The scaling code module 130 can utilize the screen scaling metric as the font size of the root DOM node to scale the user interface of the hybrid application 122 in accordance with the details provided above with regard to the use of rem units, and as will be described in greater detail below with reference to FIG. 3.

Turning now to FIG. 2, aspects of a method 200 for scaling web content will be described in detail, according to an illustrative embodiment. It should be appreciated that the logical operations described herein with respect to FIG. 2 and FIG. 3 are implemented (1) as a sequence of computer implemented acts or program modules running on a computing system and/or (2) as interconnected machine logic circuits or circuit modules within the computing system. The implementation of the various components described herein is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations may be performed than shown in FIG. 2 and FIG. 3 described herein. These operations may also be performed in parallel, or in a different order than those described herein.

For purposes of illustrating and describing the concepts of the present disclosure, the methods disclosed herein are described as being performed by the computing device 102 executing the software components described herein above. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 200 will be described from the perspective of the scaling code module 130 executing on the computing device 102 in accordance with one embodiment of the concepts and technologies disclosed herein. The method 200 begins at operation 202, where the scaling code module 130 polls the rendering engine 120 for screen metrics of the screen component 124. The polling operation performed at operation 202 can include the scaling code module 130 requesting the screen metrics from the rendering engine 120. The frequency with which the scaling code module 130 requests screen metrics from the rendering engine 120 can be defined in the scaling code module 130 and may be particular to certain implementations, such as certain devices, device types, operating systems types, or some other criteria.

For implementations in which the rendering engine 120 is or is part of WEBKIT, the polling operation can include the scaling code module 130 requesting values for particular properties in WEBKIT. For example, the scaling code module 130 may request values for a document.body.clientWidth property and a document.body.clientHeight property of WEBKIT.

From operation 202, the method 200 proceeds to operation 204, where the scaling code module 130 determines whether the screen metrics received from the rendering engine 120 during the polling operation are consistent. As described above, the screen metrics may be considered “consistent” when the screen metrics reported by the rendering engine 120 fluctuate within a specified range, do not fluctuate, or fluctuate within a specified range for a specified period of time. If the scaling code module 130 determines that the screen metrics reported by the rendering engine 120 are inconsistent, the method 200 proceeds back to operation 202, where the scaling code module 130 continues polling the rendering engine 120 for screen metrics. If, however, the scaling code module 130 determines that the screen metrics reported by the rendering engine 120 are consistent, the method 200 proceeds to operation 206.

At operation 206, the scaling code module 130 obtains the consistent screen metrics from the rendering engine 120. From operation 206, the method 200 proceeds to operation 208, where the scaling code module 130 calculates an average of the screen metrics obtained at operation 206. From operation 208, the method 200 proceeds to operation 210, where the scaling code module 130 determines a generalized screen size based upon the average of the screen metrics calculated at operation 208.

As described above, generalized screen sizes may be pre-defined by the operating system 116, may be pre-defined in the scaling code module 130, or may be pre-defined elsewhere within or external to the computing device 102. Each generalized screen size may include a range of actual screen sizes. For example, two devices that report one generalized screen size might have actual screen sizes that are slightly different when measured by hand. By way of example and not limitation, the generalized screen sizes may include small, medium, large, and extra-large screen sizes, which each define a range of screen sizes in inches or some other unit of length.

From operation 210, the method 200 proceeds to operation 212, where the scaling code module 130 selects a scaling factor for the generalized screen size. The scaling factor may be a percentage or decimal value. As described above, the scaling code module 130 can include pre-defined percentages mapped to the generalized screen sizes. The pre-defined percentages may be experimentally determined and programmed into the scaling code module 130. At operation 212, the scaling code module 130 can select the pre-defined percentage mapped to the generalized screen size of the computing device 102 as determined at operation 210.

From operation 212, the method 200 proceeds to operation 214, where the scaling code module 130 calculates a value for the font size property of the root DOM node of the web content 108 to be rendered in the web view 128 of the hybrid application 122. In particular, the scaling code module 130 calculates the value based upon the scaling factor selected at operation 212 and the average of the screen metrics calculated at operation 208. From operation 214, the method 200 proceeds to operation 216, where the scaling code module 130 applies the value calculated at operation 214 as the font size for the root DOM node.

From operation 216, the method 200 proceeds to operation 218, where the scaling code module 130 scales the user interface of the hybrid application 122 based upon the value calculated at operation 214. In particular, as described above, the style sheet code 112 of the web content 108 can define font sizes for the remaining nodes of the DOM tree in rem units. Using rem units, the root node can be defined as the value calculated at operation 214, all rem units within the style sheet code 112 can be used to define a percentage of that value, and the web content 108 can be scaled based upon the rem units. Although the scaling operation is shown as a discrete operation in the method 200, the scaling operation may be merely a result of some or all of the other operations of the method 200. Also, although the relative units used to scale the web content 108 are described as being rem units, other units are contemplated, including, for example, em units. From operation 218, the method 200 proceeds to operation 220. The method 200 ends at operation 220.

Turning now to FIG. 3, aspects of a method 300 for scaling web content will be described in detail, according to an illustrative embodiment. The method 300 will be described from the perspective of the scaling code module 130 executing on the computing device 102 in accordance with one embodiment of the concepts and technologies disclosed herein. The method 300 begins at operation 302, where the scaling code module 130 calls the screen metrics API 118 to obtain screen metrics of the screen component 124 of the computing device 102. From operation 302, the method 300 proceeds to operation 304, where the scaling code module 130 receives screen metrics in response to calling the screen metrics API 118. The screen metrics can include a horizontal screen metric of the screen component 124, a vertical screen metric of the screen component 124, and a screen density of the screen component 124.

From operation 304, the method 300 proceeds to operation 306, where the scaling code module 130 calculates the diagonal of the screen component 124 from the screen metrics obtained from the screen metrics API 118 at operation 304. In particular, the scaling code module 130 can calculate the diagonal of the screen component 124 from the horizontal screen metric and the vertical screen metric. From operation 306, the method 300 proceeds to operation 308, where the scaling code module 130 selects a scaling factor based upon the diagonal calculated at operation 306 and the screen density received at operation 304. The scaling factor can be selected from a plurality of scaling factors established for different screen sizes. For example, a first scaling factor may be created for screen sizes with diagonals less than or equal to five inches; a second scaling factor may be created for screen sizes with diagonals between five inches and eight inches; and a third scaling factor may be created for screen sizes with diagonals greater than eight inches. It should be understood that these scaling factors are illustrative, and should not be construed as being limiting in any way.

From operation 308, the method 300 proceeds to operation 310, where the scaling code module 130 calculates a value for the font size property of the root DOM node of the web content 108 to be rendered in the web view 128 of the hybrid application 122. In particular, the scaling code module 130 calculates the value based upon the scaling factor selected at operation 308, the screen diagonal calculated at operation 306, and the screen density received in operation 304. From operation 310, the method 300 proceeds to operation 312, where the scaling code module 130 applies the value calculated at operation 310 as the font size for the root DOM node.

From operation 312, the method 300 proceeds to operation 314, where the scaling code module 130 scales the user interface of the hybrid application 122 based upon the value calculated at operation 214. In particular, as described above, the style sheet code 112 of the web content 108 can define font sizes for the remaining nodes of the DOM tree in rem units. Using rem units, the root node can be defined as the value calculated at operation 214, all rem units within the style sheet code 112 can be used to define a percentage of that value, and the web content 108 can be scaled based upon the rem units. Although the scaling operation is shown as a discrete operation in the method 200, the scaling operation may be merely a result of some or all of the other operations of the method 200. Also, although the relative units used to scale the web content 108 are described as being rem units, other units are contemplated, including, for example, “em” units. From operation 314, the method 300 proceeds to operation 316. The method 300 ends at operation 316.

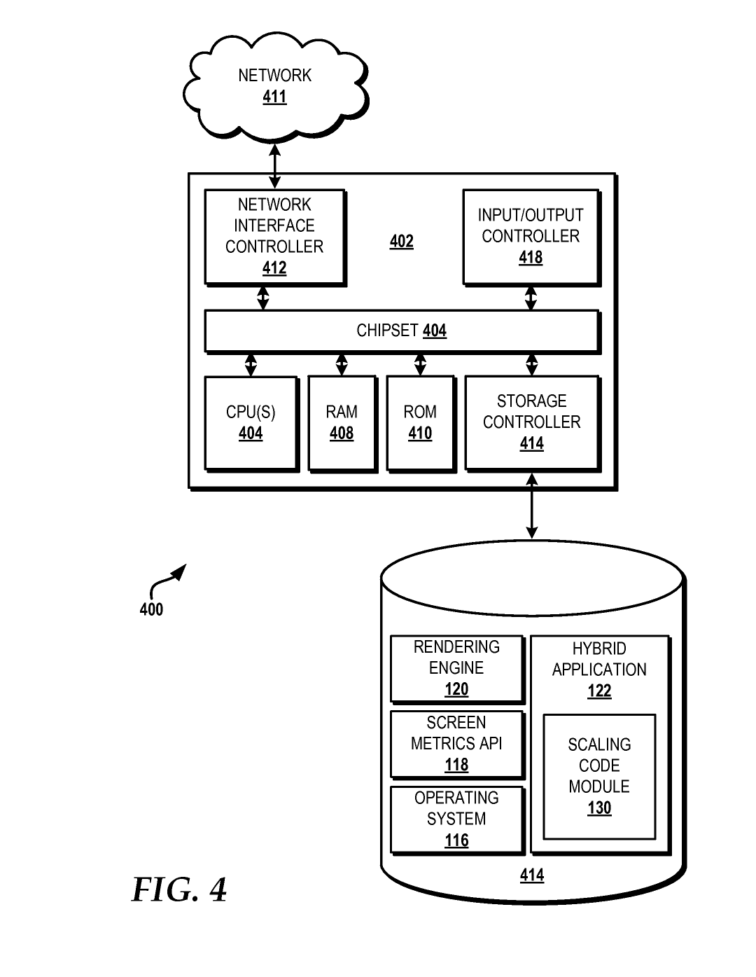

FIG. 4 shows an example computer architecture for a computer 400 capable of executing the program components described above for consistent scaling of web-based content across devices having different screen metrics. The computer architecture shown in FIG. 4 illustrates a conventional server computer, workstation, desktop computer, laptop, tablet, network appliance, PDA, e-book reader, digital cellular phone, or other computing device, and may be utilized to execute any aspects of the software components presented herein described as executing on the computing device 102, on the web server computer 104, or on any other computing system mentioned herein.

The computer 400 includes a baseboard 402, or “motherboard,” which is a printed circuit board to which a multitude of components or devices may be connected by way of a system bus or other electrical communication paths. In one illustrative embodiment, one or more central processing units (“CPUs”) 404 operate in conjunction with a chipset 404. The CPUs 404 may be standard programmable processors that perform arithmetic and logical operations necessary for the operation of the computer 400.

The CPUs 404 perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 404 provides an interface between the CPUs 404 and the remainder of the components and devices on the baseboard 402. The chipset 404 may provide an interface to a random access memory (“RAM”) 408, used as the main memory in the computer 400. The chipset 404 may further provide an interface to a computer-readable storage medium such as a read-only memory (“ROM”) 410 or non-volatile RAM (“NVRAM”) for storing basic routines that help to startup the computer 400 and to transfer information between the various components and devices. The ROM 410 or NVRAM may also store other software components necessary for the operation of the computer 400 in accordance with the embodiments described herein.

The computer 400 may operate in a networked environment using logical connections to remote computing devices and computer systems through a network 411, such as the network 106. The chipset 404 may include functionality for providing network connectivity through a network interface controller (“NIC”) 412, such as a gigabit Ethernet adapter. The NIC 412 is capable of connecting the computer 400 to other computing devices over the network 411. It should be appreciated that multiple NICs 412 may be present in the computer 400, connecting the computer to other types of networks and remote computer systems.

The computer 400 may be connected to a mass storage device 414 that provides non-volatile storage for the computer. The mass storage device 414 may store system programs, application programs, other program modules, and data, which have been described in greater detail herein. The mass storage device 414 may be connected to the computer 400 through a storage controller 414 connected to the chipset 404. The mass storage device 414 may consist of one or more physical storage units. The storage controller 414 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 400 may store data on the mass storage device 414 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 414 is characterized as primary or secondary storage, and the like.

For example, the computer 400 may store information to the mass storage device 414 by issuing instructions through the storage controller 414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 400 may further read information from the mass storage device 414 by detecting the physical states or characteristics of one or more particular locations within the physical storage units.

In addition to the mass storage device 414 described above, the computer 400 may have access to other computer-readable storage media to store and retrieve information, such as program modules, data structures, or other data. It should be appreciated by those skilled in the art that computer-readable storage media can be any available media that provides for the storage of non-transitory data and that may be accessed by the computer 400.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The mass storage device 414 may store an operating system, such as the operating system 116, utilized to control the operation of the computer 400. According to one embodiment, the operating system comprises the LINUX operating system. According to another embodiment, the operating system comprises the WINDOWS® SERVER operating system from MICROSOFT Corporation. According to further embodiments, the operating system may comprise the UNIX or SOLARIS operating systems. It should be appreciated that other operating systems may also be utilized. The mass storage device 414 may store other system or application programs and data utilized by the computer 400, such as the screen metrics API 118, the rendering engine 120, the hybrid application 122, the scaling code module 130, and/or any of the other software components and data described herein above. The mass storage device 414 might also store other programs and data not specifically identified herein.

In one embodiment, the mass storage device 414 or other computer-readable storage media is encoded with computer-executable instructions which, when loaded into the computer 400, transforms the computer from a general-purpose computing system into a special-purpose computer capable of implementing the embodiments described herein. These computer-executable instructions transform the computer 400 by specifying how the CPUs 404 transition between states, as described above. According to one embodiment, the computer 400 has access to computer-readable storage media storing computer-executable instructions which, when executed by the computer 400, perform the methods described above with regard to FIG. 2 and FIG. 3.

The computer 400 may also include one or more input/output controllers 418 for receiving and processing input from a number of input devices, such as a keyboard, a mouse, a touchpad, a touch screen, an electronic stylus, or other type of input device. Similarly, the input/output controller 418 may provide output to a display, such as a computer monitor, a flat-panel display, a digital projector, a printer, a plotter, or other type of output device. It will be appreciated that the computer 400 may not include all of the components shown in FIG. 4, may include other components that are not explicitly shown in FIG. 4, or may utilize an architecture completely different than that shown in FIG. 4.

Based on the foregoing, it should be appreciated that technologies for consistent scaling of web-based content across devices having different screen metrics have been presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Furthermore, the claimed subject matter is not limited to implementations that solve any or all disadvantages noted in any part of this disclosure. Various modifications and changes may be made to the subject matter described herein without following the example embodiments and applications illustrated and described, and without departing from the true spirit and scope of the present invention, which is set forth in the following claims.

What is claimed is:

1. A method for scaling web content, the method comprising performing, by a computing device, operations for:
receiving web content for presentation, via a hybrid application executing on the computing device, on a screen component of the computing device, the web content comprising markup language code and style sheet code;
polling a rendering engine for screen metrics of a screen component of the computing device;
determining whether the screen metrics from the rendering engine are consistent;
in response to determining the screen metrics from the rendering engine are consistent, calculating an average of the screen metrics;
determining a generalized screen size for the screen component of the computing device based upon the average of the screen metrics;
selecting a scaling factor for the generalized screen size;
calculating a value based upon the scaling factor and the average of the screen metrics;
applying the value to a font size property of a root document object model (“DOM”) node of the web content; and
scaling the web content based upon the value of the font size property and rem units defined in the style sheet code.

2. The method of claim 1, wherein the hybrid application comprises a native container and a web view within the native container, the web view being configured to present the web content.

3. The method of claim 1, wherein the rendering engine is part of WEBKIT.

4. The method of claim 1, wherein determining whether the screen metrics from the rendering engine are consistent comprises determining whether the screen metrics reported by the rendering engine fluctuate within a specified range.

5. The method of claim 1, wherein determining whether the screen metrics from the rendering engine are consistent comprises determining whether the screen metrics reported by the rendering engine do not fluctuate.

6. The method of claim 1, wherein determining whether the screen metrics from the rendering engine are consistent comprises determining whether the screen metrics reported by the rendering engine fluctuate within a specified range for a specified period of time.

7. The method of claim 1, wherein determining the generalized screen size comprises selecting the generalized screen size from a plurality of generalized screen sizes, each generalized screen size of the plurality of screen sizes comprising a range of screen sizes.

8. The method of claim 7, wherein the plurality of generalized screen sizes is defined by an operating system executing on the computing device.

9. The method of claim 1, wherein selecting the scaling factor for the generalized screen size comprises selecting the scaling factor from a plurality of pre-defined scaling factors.

10. The method of claim 9, wherein the plurality of scaling factors are percentages.

11. A method for scaling web content, the method comprising performing, by a computing device, operations for:
receiving web content for presentation, via a hybrid application executing on the computing device, on a screen component of the computing device, the web content comprising markup language code and style sheet code;
calling a screen metrics application programming interface (“API”);
receiving screen metrics from the screen metrics API;
selecting a scaling factor based upon the screen metrics of the screen component;
calculating a value based upon the scaling factor and the screen metrics;
applying the value to a font size property of a root document object model (“DOM”) node of the web content; and
scaling the web content based upon the value of the font size property of the root DOM node and rem units defined in the style sheet code.

12. The method of claim 11, wherein the screen metrics API is exposed by an operating system executing on the computing device.

13. The method of claim 11, wherein selecting the scaling factor comprises selecting the scaling factor from a plurality of pre-defined scaling factors.

14. The method of claim 11, wherein the screen metrics comprise a horizontal metric of the screen component, a vertical metric of the screen component, and a screen density metric of the screen component, and further comprising calculating a diagonal of the screen component based upon the horizontal metric and the vertical metric.

15. A computing device configured to scale web content, the computing device comprising:
a screen component;
at least one processor; and
a computer-readable storage medium having computer-executable instructions stored thereon which, when executed on the at least one processor, cause the computing device to
receive web content,
select a scaling factor for scaling the web content for presentation on the screen component,
calculate a value utilizing the scaling factor and a screen metric of the screen component,
apply the value to a font size property of a root document object model (“DOM”) node of the web content, and
scale the web content for presentation on the screen component based upon the value of the font size property of the root DOM node and a relative unit defined in the web content.

16. The computing device of claim 15, wherein the computer-readable storage medium has further computer-executable instructions stored thereon which, when executed by the at least one processor, cause the computing device to:
poll WEBKIT for screen metrics of the screen component, the screen metrics comprising a metric associated with a document.body.clientWidth property of WEBKIT and a metric associated with a document.body.clientHeight property of WEBKIT;
determine whether the screen metrics received from WEBKIT are consistent;
in response to determining the screen metrics from the rendering engine are consistent, calculate an average of the screen metrics; and
determine a generalized screen size for the screen component based upon the average of the screen metrics;
wherein selecting the scaling factor for scaling the web content for presentation on the screen component comprises selecting the scaling factor for the generalized screen size, and wherein calculating the value utilizing the scaling factor and the screen metric of the screen component comprises calculating the value utilizing the scaling factor and the average of the screen metrics.

17. The computing device of claim 16, wherein determining the generalized screen size comprises selecting the generalized screen size from a plurality of generalized screen sizes, each generalized screen size of the plurality of screen sizes comprising a range of screen sizes.

18. The computing device of claim 16, wherein selecting the scaling factor for the generalized screen size comprises selecting the scaling factor from a plurality of pre-defined scaling factors.

19. The computing device of claim 15, wherein the computer-readable storage medium has further computer-executable instructions stored thereon which, when executed by the at least one processor, cause the computing device to:
call a screen metrics application programming interface (“API”);
receive screen metrics from the screen metrics API, the screen metrics comprising a horizontal metric of the screen component, a vertical metric of the screen component, and a screen density of the screen component; and
calculate a diagonal of the screen component based upon the horizontal metric and the vertical metric;
wherein selecting the scaling factor for scaling the web content for presentation on the screen component comprises selecting the scaling factor based upon the diagonal and the screen density, and wherein calculating the value utilizing the scaling factor and the screen metric of the screen component comprises calculating the value utilizing the scaling factor, the diagonal, and the screen density.

20. The computing device of claim 19, wherein the screen metrics API is exposed by an operating system executing on the computing device.

21. The computing device of claim 15, wherein the relative unit is an EM unit.

22. The computing device of claim 21, wherein the EM unit is a root EM unit.

23. The computing device of claim 15, wherein the computer-readable storage medium has further computer-executable instructions stored thereon which, when executed by the at least one processor, cause the computing device to:
hide the web content unit after scaling the web content for presentation on the screen component; and
present the web content on the screen component.
